(19) United States
(12) Patent Application Publication
(10) Pub. No.: US 2007/0206154 A1
(43) Pub. Date: Sep. 6, 2007

(54) Novel enhanced system for harmonized visual and aromatherapeutic stimuli generation

(76) Inventor: Kathryn Brady, Westminster, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/368,107

(22) Filed: Mar. 3, 2006

(51) Int. Cl. G03B 21/32

(52) U.S. Cl. 352/85

(57) ABSTRACT

A stand-alone unit includes a plurality of screens which are panels for displaying images disposed in a pre-determined geometric configuration about a base likewise housing at least a fragrance dispensing mechanism and music-playing capacity, which is harmonized at a user's discretion to create a customized personal entertainment system. A method and apparatus selectively incorporated sights, smells and sounds via advanced microelectronics as needed, or allows a user to set fragrances and images statically to achieve a desired set of effects.

### BACKGROUND OF THE DISCLOSURE

1. Field of the Disclosure

The present invention relates to systems for personalized image display in combination with fragrance control. In particular, the present invention combines a user's predetermined selection of previously or contemporaneously collected images with any number of desired fragrances, including relative concentrations of output of the same, and sound.

2. Background of the Art

At least two distinct issues are addressed and overcome by means of the instant teachings which have not heretofore been addressed on a synchronous, timed, phased—let alone harmonized basis. Owing to the advent of contemporary memory and storage issues the potential to array desired photographic images or counterpart visual schemes, and independent fragrance schemes has been vastly improved, as has musical or sound generating ability.

Likewise, given the ability to use hardware and software for the programmed scenting of environments with computer processing integration, contemporary systems can now offer for consideration vast improvements in personal environmental engineering and management. With visual stimuli being a focal point, the instant teachings facilitate positive mood enhancements in users in unprecedented fashion.

This delimiting, through the advent of technological step-changes, of our ability to engineer local and remote personal entertainment spaces makes it clear that the present disclosure satisfies longstanding needs.

### SUMMARY OF THE DISCLOSURE

The present inventor has taken a basic need for the display of a set of photographic images and linked it with state-of-the-art fragrance control to create a stand-alone system for customized visual and aromatherapeutic display, in synchrony with music or sounds, as desired or with the same optionally omitted.

Imagine that someone known or loved has just achieved a memorable milestone that can be depicted via visual images. Being remote from that person in terms of geographic distance no longer precludes wireless sharing of the subject visual images. Rather, according to the teachings of the present disclosure, one can receive them, download them onto a modular personal visual enjoyment system, and share in the experience.

Briefly stated, a stand-alone unit includes a plurality of screens which are panels for displaying images disposed in a pre-determined geometric configuration about a base likewise housing at least a fragrance dispensing mechanism and music-playing capacity, which is harmonized at a user's discretion to create a customized personal entertainment system. A method and apparatus selectively incorporated sights, smells and sounds via advanced microelectronics as needed, or allows a user to set fragrances and images statically to achieve a desired set of effects.

According to a feature of the present disclosure there is provided a system for displaying visual images, fragrances and sounds which comprises, in combination; a plurality of panels capable of displaying desired images, a fragrance emitting mechanism, a sound generating assembly whereby the plurality of panels are arranged in a predetermined geometric configuration permitting the images to be moved at an adjustable speed, the fragrance emitting mechanism is capable of being controlled by a user, and sounds are generated at least one of in synchrony with the images and fragrances and independently.

According to another feature of the present disclosure there is provided a process for displaying photographic images in combination with fragrances and sounds.

According to yet still another feature of the present disclosure there is provided a modular personal visual enjoyment system, which comprises, in combination an apparatus for receiving digital input, at least a panel for displaying visual images; a mechanism for housing and releasing fragrances, a sound emitting assembly; and a power source.

### DRAWINGS

The above-mentioned features and objects of the present disclosure will become more apparent with reference to the following description taken in conjunction with the accompanying drawings wherein like reference numerals denote like elements where needed and are omitted if not needed, and in which:

FIG. 1A is a frontal view of an exemplary embodiment of the present disclosure showing a panel according to example 1;

FIG. 1B is a side view of an exemplary embodiment of the present disclosure showing a panel according to example 1;

FIG. 2 shows an exemplary circuit board of an exemplary embodiment of the present disclosure showing a panel according to example 1;

FIG. 3 is another view of the embodiment of the present disclosure according to example 1;

FIG. 4 is another view of the embodiment of the present disclosure according to example 1;

FIG. 5 is another view of the embodiment of the present disclosure according to example 1;

FIG. 6 is another view of the embodiment of the present disclosure according to example 1;

FIG. 7 is another view of the embodiment of the present disclosure according to example 1;

FIG. 8 is a first view of an alternate fragrance dispensing embodiment according to the teaching of the present invention; and

FIG. 9 is a second view of an alternate fragrance dispensing embodiment according to the teaching of the present invention.

### DETAILED DESCRIPTION OF THE DISCLOSURE

The present invention has taken an original concept which involved employing a box-shaped free-standing photograph display unit and fragrances and updated it by linking up modern computer, microelectronic and image display technology. In so doing, a user's ability to control rapid image processing, speed and timing of fragrance-based stimuli and sound have been harmonized. Accordingly, the teachings of the present disclosure are offered herein for consideration as progress in science and the useful arts.

According to the disclosure of the instant teachings, as manifested in the following illustrative examples, the instant disclosure provides for an integration of cutting edge display and touch screen specifications with the teachings of aromatherapy and harmonic euphony, as now available to save, use, store, and download. The exemplary embodiments discussed are not meant to be limiting, rather to show working prototypes in play, currently which demonstrate the present inventor's contributions to the art.

### EXAMPLE 1

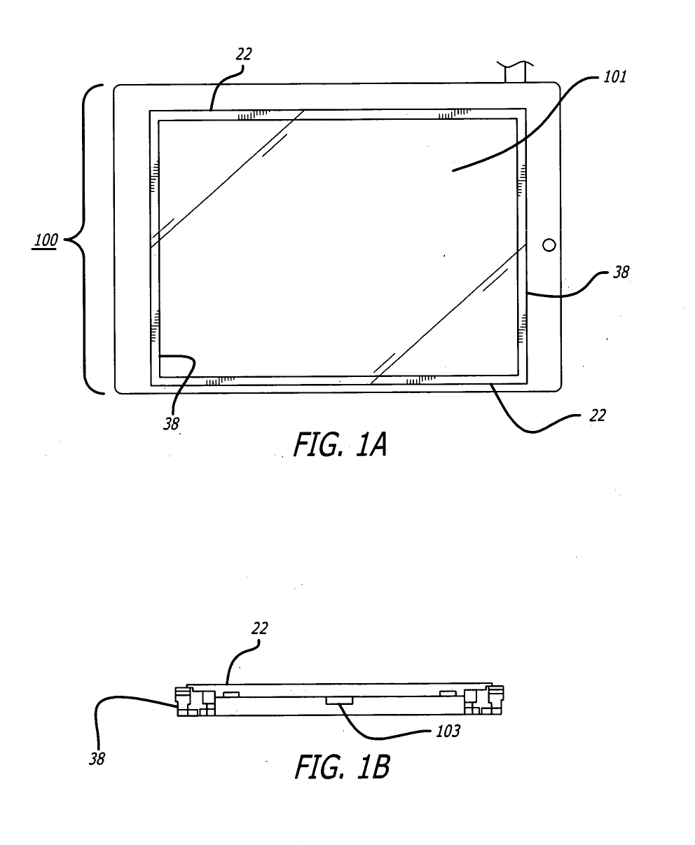

Turning to FIG. 1, an exemplary top view (FIG. 1A) and side view (FIG. 1B) which may be used to make, for example, a box-shaped stand alone unit having, for example, a six-inched measurement for each side. Screen 101 is manifested in an LCD display having an integrated resistive touch screen, circumscribed by first and second elements 38 and 22 (which are then shown as having the same site dimension in this embodiment). Those skilled in the art understand that neither first nor second elements 38, 22 are required to be the size shown, or the same size.

The embodiment of FIG. 1 can use any conventional, LCD display as screen 101, such as those which connect directly to XSCALE-LITE and XSCALE-MINI with the support of a 34-pin flat ribbon interface cable (RLC Enterprises, Orange County, Calif.). Screen 101 is conveniently bordered by first and second elements 38 and 22 to form box-shaped unit 100. As shown, a color TFT QVGA LCD (320×240, 64,000 colors) Display can be used as screen 101. Those skilled in the art readily understand this to include an integrated power supply, backlight generator, backlight control and an integrated resistive touch screen. In such a system, the signals for the LCD/XScale unit can be provided by single ribbon cable, and software is also known.

Referring to FIG. 1B frame elements 38 and 22 are shown along with port 103 for receiving the conventional microelectronics. Such features are conventional and may include a fully-featured single board computer having an Intel® brand of SA-1110 StrongARM risk microprocessor with an SA-1111 companion chip.

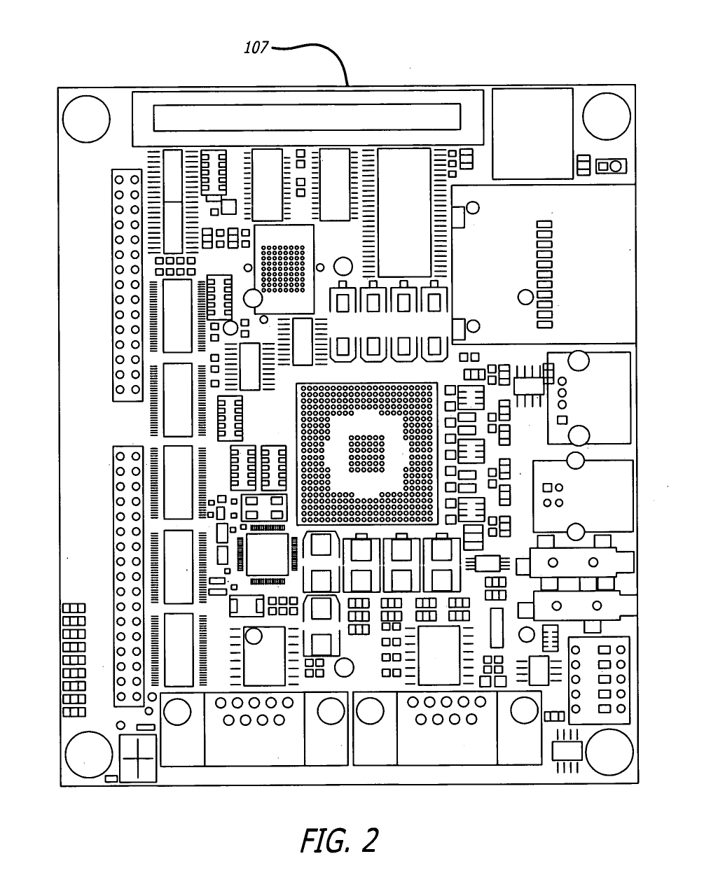

FIG. 2 illustrates illustratively an eight layer board 107, whereby a microprocessor having sufficient memory and bandwidth is embodied. For example, a digital StrongARM SA 110 RISC processor may be used, in combination with at least about a gigabyte to 80 gigabytes of on-board memory (Toshiba America Storage Device Division, Irvine, Calif.). Details of the specifications for the involved microelectronics are conventional and provided in Appendix A, so further details are omitted at this time, to the extent they would be understood by artisans.

### EXAMPLE 2

The present inventor is marketing a line of modular digital stand alone units (The IN MY BOX™ brand of personal visual enjoyment system, Orange County, Calif.) which allow users to take photographs from any number of different medial and array them with fragrances and sounds, using the latest in microelectronic technology.

According to the instant teachings there is provided a combination of conventional microelectronic technology to array photographic images and controlled fragrance emitting technology, whereby sounds are likewise coordinated. Included among the teachings are both known and after-developed usages of both natural and synthetic scents, which are becoming increasingly known to have neuroscientifically proven impacts upon human perception.

For example, substances ranging from coffee to cinnamon have been shown to have stimulating effects upon consciousness, and to be related to specific neurotransmitter uptake-such as serotonin, dopamine and related endogenous compounds. In the aromatherapeutic arts the opposite effects are known to result from the use of calming (often herbal) scents such as those derived from chamomile flowers, hibiscus, lavender and mint.

It is also known to use extracts from plants, such as Echinacea and Goldenseal to provide relief from allergic symptoms, minor congestion and the like. Furthermore, with the advent of Eastern medicine, ginseng, gingko-biloba and various “tonic” types of herbs can be used to impact moods, awareness and have therapeutic effects—such as vasodilatation, which provides for stress relief. Expressly incorporated by reference herein are U.S. Pat. Nos. 5,972,290; 5,651,942; 5,361,522, 4,714,984, 5,950,922, Des. 269,902, 4,301,095 and Des. 360,461 each of which defines the state of the art but is readily distinguishable.

Medicinal and religious-ritual based compounds and substances likewise are contemplated to place within the teachings of the present invention. For example, those having prescriptions may undergo medical usage of various herbs including, for example Cannabis sativa, Cannabis indicum and recent Supreme Court of the United States case law suggests more exotic and ritualistic usages of certain substances from Brazil, South America, including teas and incense.

Referring now also to FIG. 7-FIG. 9 two alternate mechanisms are offered for consideration relative to the production of scented, or fragrance emitting aspects of the present disclosure. In FIG. 7 dispensing wheel 301 comprises wells 303 effective for housing appropriately sized aliquots of scent-producing chemical extracts (not shown). Heating element 308, vaporizes the scent-producing chemical extracts which then waft out and create a desired affect. Those skilled in the art will readily understand rotation and heat level and impacts on concentration.

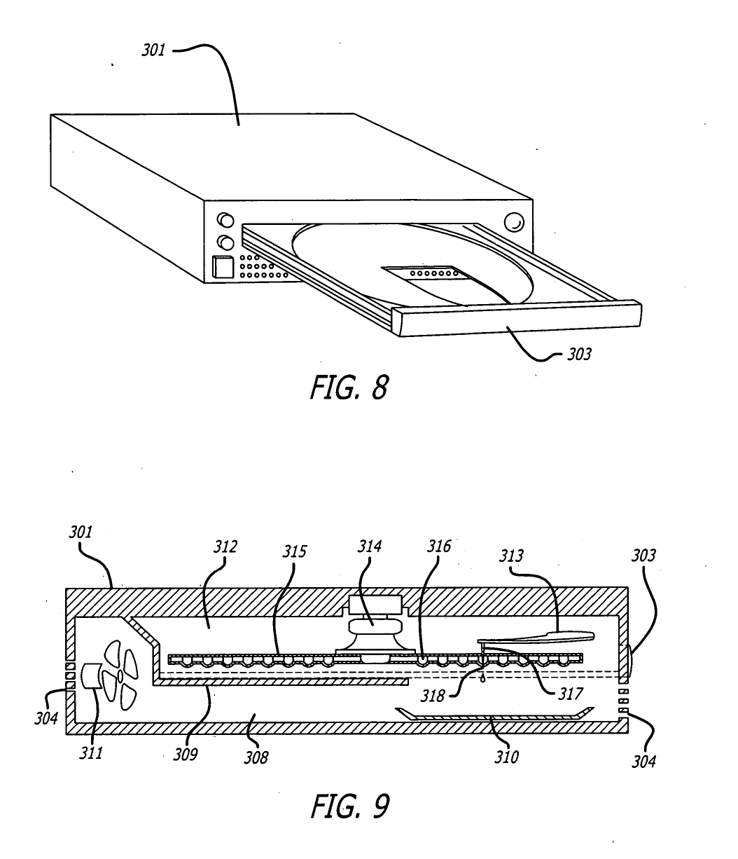

Referring now to FIG. 8-FIG. 9, unit 301 has trough 304 with the interior of the box 301 contains a lower compartment 308 and an upper compartment 312. The upper and lower compartments are separated by a corner plate 309, which extends from the rear of said box 301 until an intermediate section 9″, forming a sort of channel in said compartment 308 and the housing for a disk processing mechanism. The lower compartment 308 has a rear space in which a small fan 311 is installed, for directing air toward a container 310 located in the forward section of the compartment 308.

The disk processing mechanism is of the kind that fits into a center orifice 314 of a disk 315 bearing small capsules of fragrances 316. The disk processing mechanism 313 operates with a perforation device 317 that is moveable by drive means (not shown) in a vertical direction and is equipped with a pointed element 318 that serves to selectively puncture the capsules 316 containing the fragrances. Therefore, these capsules 316 must be manufactured from an appropriate material that is suitable to be punctured by this pointed element 318.

The equipment described above is electronic and operates by any available digital source and/or on commands received from a compact disc, or computer program. Thus a disk 315 containing a determined sequence of fragrance capsules 16, previously programmed in tune with an image, image set, series of images, a motion picture, or a show, is conveniently inserted into the drawer 303, which is immediately closed. The equipment is turned on at the beginning of the event, and then in synchronization with the sequence of the scenes that are being shown, and whenever a specific fragrance is required, the mechanism turns the disk 315 and places the respective fragrance capsule that is required under the device 317, in order that with an up and down vertical motion of device 317, capsule 316 is pierced with the pointed element 318.

At that instance, the scenting substance or compound contained in the foregoing capsule 316 is released into the container 310. The small fan 311 turns on, drawing air through the small rear orifices 307 producing a draft in compartment 308 under plate 309 for dispersing the fragrance through the small forward orifices 302. In this fashion the fragrance is released into the environment in which the event is being held, spreading throughout the environment and thereby creating an atmosphere of reality for the audience. This procedure is repeated by the equipment, which will select the capsule to be punctured for the next scene in which a specific fragrance is required.

The fragrance's persistence can be controlled, for instance, by the very chemical formulation previously produced for the respective event. Also, the duration of the fragrance can be controlled through odor inhibiting agents, such as chemical inhibitors, which may be included in, the set of capsules 316. Thus, each event shall have its disk with the corresponding sequences of fragrances. However, this does not exclude the introduction of random scents for a specific event.

The operation of the equipment as a whole, or be it, the mechanism, perforation device 317 and fan 311, are controlled-by electronic commands that are inaudible to the audience. By the same token, the medium of these elements are such as not to produce any strange sounds or undesirable noises perceptible during the event. In preferred embodiments, suitable electronic control apparatus (not shown) is provided for controlling the operation of mechanism, selectively rotating the disk and containing the perforation device 317. The control apparatus may be responsive to a timer for releasing scents in predetermined time periods, timed from, for example, the initiation of the event. Alternatively, the control apparatus may be responsive to synchronization signals produced during the event. Such signals may be recorded on the medium on which the event is recorded or may be produced independent of the event and transmitted electronically, electromagnetically or optically to the control apparatus. Suitable electronic apparatus capable of controlling the operation of mechanism would be within the scope of one skilled in the art.

The process and the equipment, according to embodiments of the present invention can be produced for a variety occasions. Thus, for instance, such processes and equipment may be provided for already existing movies and programmed so that they may be synchronized with the sequences of the scenes; old movies may be reissued with signals for the synchronization of the equipment; or tapes or other recording media may incorporate the signals for the synchronization with the equipment.

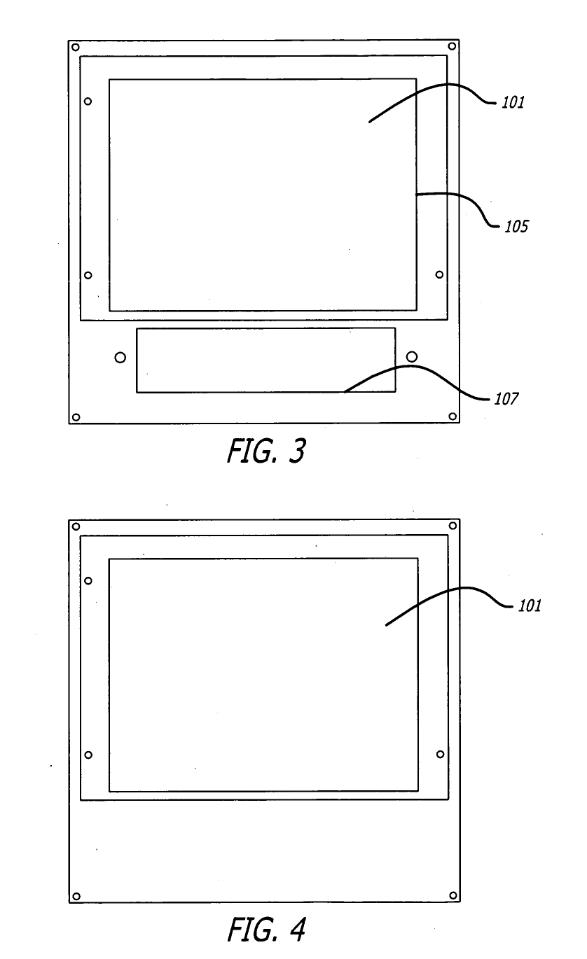

Referring now to FIG. 3, panel 101 is maintained in a desired posture by framing element 105 as known to those skilled in the LCD arts. Unknown card reader slot 107 is effective to accept a media card (not shown) and may be swapped out for a USB port.

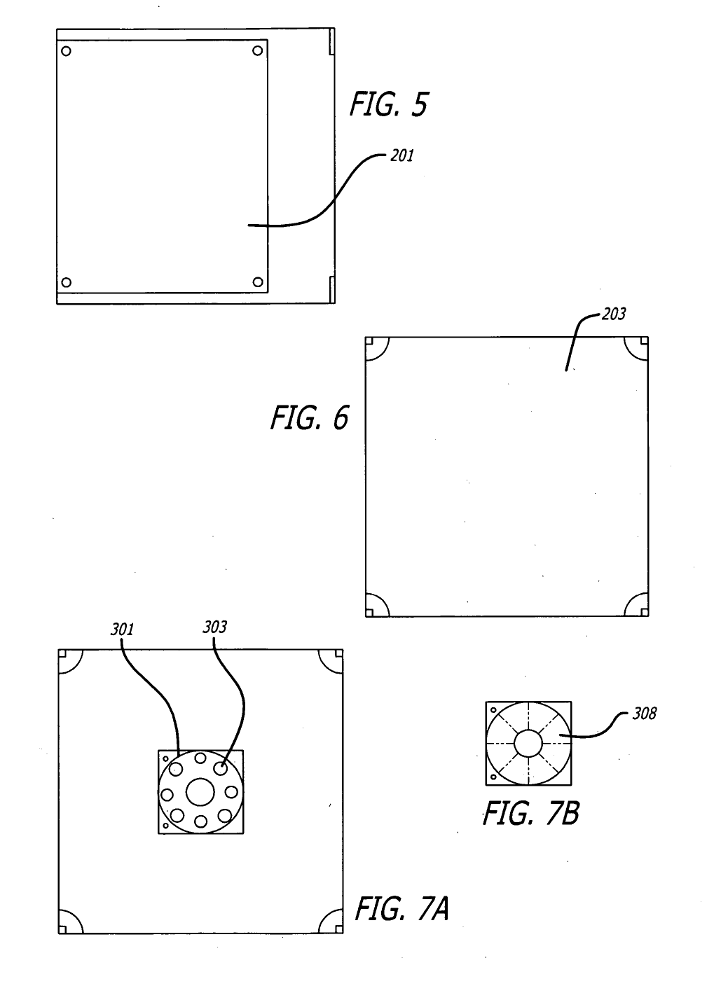

FIG. 4 and FIG. 5 show further construction details for the exemplary embodiment shown, including the bottom 201 and back 203 of an assembled panel set. Those skilled in the microelectronic arts will understand that numerous power sources, ranging from rechargeable batteries to chargers with holster may be used to support the instant teachings.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A system for displaying digital visual images, fragrances, and sounds comprising, in combination:
a plurality of panels capable of displaying desired photographic images;
a fragrance emitting mechanism allowing a user to choose fragrance type and intensify from a predetermined set of fragrances; and,
a sound generating assembly including speakers and volume control;
whereby the plurality of panels are arranged in a predetermined geometric configuration permitting the images to be moved at an adjustable speed, the fragrance emitting mechanism is capable of being controlled by a user, and sounds are generated at least one of in synchrony with the images and fragrances and independently.

2. The system of claim 1, further comprising a stand-alone unit.

3. The system of claim 2, further comprising a single board computer.

4. The system of claim 3, further comprising at least one mechanism for importing data from a remote source selected from the group consisting of Blue-Tooth® brand of technology, a USB port, a media card reader, and an Ethernet connection.

5. The system of claim 2, further comprising a mechanism for connecting to a power supply.

6. The system of claim 2, wherein digital signals from a cellular phone may be imported.

7. The system of claim 2, where said system is modular.

8. A modular personal visual enjoyment system, which comprises, in combination:
an apparatus for receiving digital input;
at least a panel for displaying visual images;
a mechanism for housing and releasing fragrances;
a sound emitting assembly; and
a power source.

9. The modular personal visual enjoyment system of claim 8, further comprising at least one mechanism for importing data from a remote source selected from the group consisting of Blue-Tooth® brand of technology, a USB port, a media card reader, and an Ethernet connection.

10. The modular personal visual enjoyment system of claim 9, whereby the at least one panel further comprises a plurality of panels arranged in a predetermined geometric configuration permitting the images to be moved at an adjustable speed, the fragrance housing and releasing mechanism is capable of being controlled by a user, and sounds are generated at least one of in synchrony with the images and fragrances and independently.

11. The modular personal visual enjoyment system of claim 8, wherein the said emitting assembly is detachably removed from the remainder of the system.

12. The modular personal visual enjoyment system of claim 8, wherein the said mechanism for housing and releasing is detachably removed from the remainder of the system.

13. The modular personal visual enjoyment system of claim 8, wherein said mechanism for housing and releasing fragrance further comprises a compact-disc-like element housing fragrance capsuler, and a pointed element in combination with a small fan and a drawer opening and closing apparatus.

14. A process for arraying sights, smells and sounds, comprising, combination:
providing a stand alone unit having LCD panels effective to display digital images, an on-board microprocessor, sound generating mechanisms and a fragrance emitting unit;
downloading desired digital images in the unit;
selecting a desired fragrance to be emitted;
choosing, optionally, desired sounds to accompany the digital images and fragrances;
repeating any of the above steps.

15. The process of claim 11, wherein the downloading step further comprises utilizing at least one mechanism for importing data from a remote source selected from the group consisting of Blue-Tooth® brand of technology, a USB port, a media card reader, and an Ethernet connection.

16. The process of claim 11, whereby the providing step comprises a plurality of panels arranged in a predetermined geometric configuration permitting the images to be moved at an adjustable speed, the fragrance housing and releasing mechanism is capable of being controlled by a user, and sounds are generated at least one of in synchrony with the images and fragrances and independently.

17. The process of claim 11, the selecting step further comprising using a heating element and a plate housing desired fragrances.

18. The process of claim 11, the selecting step further comprising a compact-disc-like element housing fragrance capsules and a pointed element in combination with a small fan and a drawer opening and closing apparatus.

19. The process of claim 11, the providing step further comprising an alternate video display element within the stand along unit.

20. The process of claim 11, wherein the downloading step includes images other than digital.
